(19) United States
(12) Patent Application Publication
(10) Pub. No.: US 2024/0072280 A1
(43) Pub. Date: Feb. 29, 2024

(54) METHOD FOR STARTING A FUEL CELL STACK, COMPUTER PROGRAM PRODUCT FOR PERFORMING THE METHOD AND FUEL CELL SYSTEM HAVING A FUEL CELL STACK

(71) Applicant: EKPO Fuel Cell Technologies GmbH, Dettingen (DE)

(72) Inventors: Dominik BERON, Stutensee (DE); Jürgen KRAFT, Metzingen (DE); Stefan HEMMER, Metzingen (DE); Tobias KRÜGER, Nehren (DE); Michael GÖTZ, Dettingen/Erms (DE)

(73) Assignee: EKPO Fuel Cell Technologies GmbH, Dettingen (DE)

(21) Appl. No.: 18/457,910

(22) Filed: Aug. 29, 2023

(30) Foreign Application Priority Data
Aug. 30, 2022 (DE) 102022121832.5

(51) Int. Cl. H01M 8/04225; H01M 8/04029; H01M 8/04746

(52) U.S. Cl. CPC H01M 8/04225; H01M 8/04029; H01M 8/04768; H01M 2008/1095

(57) ABSTRACT

The present invention relates to a method for starting a fuel cell stack at temperatures below the freezing point of a reaction product produced during the reaction between an anode-side fuel and a cathode-side fuel. The fuel cell stack comprises a plurality of individual cells having at least one internal cell which is arranged in the stacking direction in the interior of the fuel cell stack and an edge cell which is arranged in the stacking direction at the edge of the fuel cell stack. The fuel cell stack is connected to a cooling circuit having cooling fluid for cooling the fuel cell stack, which cooling fluid can be conducted through the fuel cell stack by a pump arranged in the cooling circuit. The method includes the step of applying a load to the fuel cell stack for drawing a first increasing current from the fuel cell stack, thereby decreasing an output voltage of the fuel cell stack, while the pump does not conduct cooling fluid through the fuel cell stack, until a first predetermined condition is met. In addition, the invention provides a computer program product with computer-executable instructions for carrying out the method and a fuel cell system.

### RELATED APPLICATION

This application claims priority to German application No. 10 2022 121 832.5 filed on Aug. 30, 2022, which is incorporated herein by reference in its entirety and for all purposes.

### FIELD OF DISCLOSURE AND BACKGROUND

The present invention is in the field of fuel cell technology. Fuel cells are typically combined to form so-called fuel cell stacks.

### SUMMARY OF THE INVENTION

FIG. 1 shows a schematic structure of a cell known per se and the corresponding chemical reactions therein. An anode 3 and a cathode 4 accommodate a solid electrolyte 1 between each other. Typically, the cathode 4 and the anode 3 are connected to a current collector plate 5, 6 via which the corresponding current generated by the cell is tapped. The present example is a so-called PEMFC (proton exchange membrane fuel cell). Hydrogen is fed as fuel on the anode side and air (or also oxygen) is fed on the cathode side. The reaction produces water as reaction product. In FIG. 1, this is discharged through the channel at the top of the figure. In any case, fuel feed channels via which fuel is supplied are associated with the anode 3 and the cathode 4.

The individual cells are typically combined to form stacks. This is shown schematically in FIG. 2. In FIG. 2, the membrane electrode assemblies are provided with reference signs 7. Said assemblies are constructed from the solid electrolyte, the anode and the cathode, which are shown as an example in FIG. 1.

In the present case, fuel channels 9 are provided in the corresponding separators 8. These are supplied with fuel by means of inlets and outlets on the end plates 10. In this case, reference signs 11a and b denote the corresponding inlet and outlet for the hydrogen, that is to say the anode-side fuel, and reference signs 12a and b denote the inlet and outlet for the corresponding cathode-side fuel, in the present case oxygen. In the example in FIG. 2, a cell is arranged centrally in the direction of the stacks. This is surrounded by edge cells provided at the edge of the fuel cell stack.

FIG. 3 shows a schematic view where a whole series of such fuel cells 13 are provided in a fuel cell stack. The latter is held between the end plates 10 in which the corresponding inlet and outlet 11a, 11b, 12a, 12b are also provided in the present case for the hydrogen or the oxygen (or air). In any case, such a fuel cell stack comprises at least edge cells, which lie at the outermost edge in the stacking direction, and also fuel cells, which are provided in the interior of the cell. In the present case, all cells which are not edge cells are cells which are provided in the interior.

Overall, in fuel cell technology, there is the problem that, for example, the reaction product has a certain temperature at which it solidifies (freezing temperature). If the fuel cell is a hydrogen-based fuel cell and hydrogen and oxygen are used as fuel, the reaction product is water and the freezing point is about 0° C.

Nowadays, such fuel cells, in particular PEMFC fuel cells, are used in vehicle construction or also in aircraft construction as well as in many other areas as supplies of energy. In this case, it is possible that these fuel cells, if these are not used, are mounted in a temperature environment which is below the freezing point of the reaction product. This leads to a large number of problems.

In their normal operation, common PEMFC fuel cells operate, for example, at a temperature between 60° C. and 80° C. This operation is referred to as normal operation. It is possible that these fuel cells have a temperature of −25° C. or even lower during a cold start. Then the reaction product water freezes immediately within the cells and degradation and cell damage occur. In particular, this cold is problematic for the edge cells since they have no further adjacent heat source next to them.

Although different solutions are known for such a low-temperature (frost) start, all previously known solutions have disadvantages.

Proceeding from this problem, the present invention proposes a method having the features of claim 1. This is characterized in particular in that a load is applied to the fuel cell stack so that a first increasing current is taken from the fuel cell stack. This reduces the voltage of the fuel cell stack. At the same time, heating of the entire stack or of the corresponding cells is achieved by this first increasing current. According to the present invention, a load is supplied with an increasing current until a first predetermined condition is met. This step is referred to below as step a).

The increasing current can form a current ramp in the time-current diagram, wherein the current preferably increases substantially linearly. The current increase per time can be in particular in the following range: at least about 5 A/s, in particular at least about 10 A/s, and/or at most about 50 A/s, preferably at most about 30 A/s. For example, a current ramp can be possible in the entire range between 10 A/s and 30 A/s.

At the same time, during the first increasing current in this time until the first predetermined condition is met, no filling fluid is pumped through the cooling circuit or through the fuel cell stack. It is thus possible to heat the corresponding fuel cell stack quickly.

The first predetermined condition is selected in particular so that the fuel cell stack does not become too hot or so that individual cells in the stack do not become too hot and thus degrade.

As a first predetermined condition, it can be selected that a predetermined time of, for example, 5 to 60 seconds, preferably 10 to 30 seconds, is waited. A waiting time of approximately 30 seconds can be provided in particular at a temperature of approximately −30° C. As an alternative or in addition, it can be detected whether or not a temperature measured within the fuel cell stack is exceeded. In particular, this temperature measured within the fuel cell stack is the temperature at the cathode.

As a further alternative, it can be selected as the first predetermined condition that a PTC element is switched off in a PTC element cooling circuit which makes up a part of the cooling circuit. The configuration with the PTC element is described in detail further below.

The monitoring of the condition can take place continuously or periodically and a control loop can be configured which ensures that the current increases until the corresponding first predetermined condition is met.

However, depending on the configuration, it is also possible for a voltage close to zero or even a negative voltage to prevail between the anode or the cathode in the corresponding cell. This is also harmful to the cell. Thus, it is particularly advantageous that during step a) the cell voltage one of the cells or of the entire cell stack is monitored so that it does not fall below a predetermined minimum value. In particular, it is advantageous to monitor at least the cell voltage of the edge cell since, by reason of its position, because it has only one adjacent cell, a particularly high voltage drop occurs. The current output is adjusted so that the voltage does not fall below the predetermined minimum value.

However, this is not necessary in particular if such a reduced voltage does not cause the corresponding cells to degrade. Then, as described in claim 13, a temperature measured within the fuel cell stack cannot be monitored at all.

This is advantageous when the cell (or the cells) has/have a so-called CRT function (cell reversal tolerance). In this case, for example, the anodes are doped with small amounts of iridium or other metals are admixed, which, in the event of an undersupply of the anode due to its own irreversible depletion, for example of iridium, provide the necessary electrodes in order to keep the electrochemical reaction going and to be able to supply a required system load. Thus, individual or multiple cells or all of the cells in the fuel cell stack can be equipped with a so-called CRT functionality.

According to a development of the invention, it is advantageous after the previously described step a) to carry out the following steps b) and c). Here, step b) is the step of configuring the pump to conduct the cooling fluid through the fuel cell stack at a first flow rate and step c) is the reducing of the current intensity output by the fuel cell stack by adjusting the load.

If the cell or the cells in the fuel cell stack are now heated by applying the load and the first increasing current, in step b) this heat can now be uniformly distributed over the cooling circuit, including in the entire fuel cell stack. So that the internal cells in the fuel cell stack do not overheat, in step c), for example, the current which is drawn can be reduced again.

These steps are carried out, for example, after step a), wherein step a) is also referred to below as the first phase and the combination of steps b) and c) is also referred to as the second phase.

The second phase is preferably ended when a second predetermined condition is met. This second predetermined condition can be that a temperature difference between a coolant temperature at an outlet of the fuel cell stack and a coolant temperature at the inlet of the fuel cell stack falls below a predetermined value. This value indicates that the entire coolant in the circuit or a partial circuit is heated a little and, essentially, is distributed fairly uniformly in the circuit.

The monitoring of this second predetermined condition can also take place in a control loop and the application of the current (in step c), which is reduced compared to step a), and/or the operation of the pump (in step b) can be configured as a function of the values of the second predetermined condition.

As soon as this second predetermined condition is met, a third condition can be checked according to a further aspect of the invention. If this third condition is met, the method proceeds, for example, to a third phase (where, for example, steps e) and f) explained below are carried out). If the third predetermined condition is not met, the method is fed back into the first phase and then the first and second phases are run through until the third predetermined condition is met.

This third predetermined condition can be that a temperature of the coolant within the cell or within the fuel cell stack is above a certain value. This is, for example, the absolute temperature. This indicates that, for example, the coolant has a temperature above the freezing point and thus the problem that the reaction product freezes and the cell degrades no longer occurs.

As soon as this third condition is met, a transition is made to the third phase, for example.

In this third phase, steps e) and f) in claim 8 can be carried out. These steps can be carried out until one or more further conditions are met.

Here, step e) is an operation of the pump such that the cooling fluid is conducted through the fuel stack with a second flow rate that is reduced compared to the first flow rate in step b) or that the pump is completely switched off. It is also possible that the pump is operated at the second flow rate for some time and is switched off for some time, and that this also takes place in alternating fashion (periodically).

Step f) is the application of such a load that the fuel cell stack supplies this with an increasing current. The increasing current is referred to below as the second increasing current. The increase does not have to be as high as that in step a) in the first phase, but can be the same. In particular, it is advantageous that the increase or the current ramp is not as steep as the current ramp in step a.

By combining a somewhat smaller cooling flow in step e) than the cooling flow in step b) and heating the stack by applying a load to the fuel cell stack in step f), the temperature of the fuel cell stack is further increased in particular in order to reach an operating temperature.

The following conditions or a combination thereof can be used as one or more further conditions with which the completion of the third phase is determined.

A voltage difference between an average voltage of the fuel cell stack and a minimum voltage of a cell in the fuel cell stack can be taken into account and whether this voltage difference is below a predetermined value. Typically, the edge cells have the minimum voltage among the cells in the stack.

If, for example, cooling blocks of other functionalities are also provided within the cell stack, cells which only have two directly adjacent cells can also be provided there. Said cells can also show such a minimum voltage. The average voltage is the voltage averaged over the individual cells of the stack. If the corresponding voltage difference is below a predetermined value, this indicates that the stack is uniformly heated.

A time period for which at least the temperature of the coolant must be above a certain value can also be easily determined as an additional or alternative further condition.

The corresponding further conditions can also be checked by means of a control loop in the third phase and the corresponding current and coolant flows in steps e) and f) can be used until the corresponding further predetermined condition is met.

If one and/or multiple further conditions are met, the fuel cell stack can then transition (be operated) from the third phase in its normal operation. This normal operation is typically an operation having a relatively high cooling capacity, i.e., the coolant pump is operated in such a way that an even higher coolant flow through the cell is generated in relation to the coolant flow from the second or third phase, in particular a “steady state” is to be achieved and heating of the fuel cell stack by a current draw then does not take place further.

The previously described fuel cell stack can have any configuration and is not limited to a fuel cell stack in which hydrogen and oxygen are used as fuel. However, the fuel cell stack can in particular be a PEMFC fuel cell, wherein water is formed as the reaction product.

In addition to the above-described aspects, alternatively or additionally the cooling circuit can also have a section which is defined as a PTC element cooling circuit. As viewed in relation to the entire cooling circuit, this PTC element cooling circuit can be a smaller cooling circuit, which makes up a part of the cooling circuit. A PTC element (positive temperature coefficient), which heats the cooling fluid in the part of the cooling circuit when a voltage is applied to this PTC element, can be contained in this PTC element cooling circuit. The PTC element can be supplied with current to apply the voltage, whereby the cooling fluid is heated up. The heated cooling fluid can also, on the one hand, be conducted through the one or more fuel cells of the fuel cell stack, or, alternatively or additionally, can also supply heat to a heat exchanger upstream of the fuel cell stack.

Such a heat exchanger can be a charge air cooler arranged upstream of the cathode inlet, or an anode heat exchanger provided upstream of the anode inlet. The corresponding fuels which are fed to the cells can be preheated by means of these heat exchangers. The problem of the reaction gas freezing is thus also reduced.

In particular, it is advantageous that the current with which the PTC element is supplied is tapped by the fuel cell during step a) or by the fuel cell stack during the previously described method. The PTC element thus represents the above-described load.

According to a further development of the invention, in the method described above, the predetermined conditions or temperatures can be monitored only in the edge cell or in one or more cells adjacent thereto or also only an individual blocks of cells of the fuel cell stack. In particular, the temperature can be the temperature of the cathode of the corresponding cell.

According to a parallel aspect of the invention, the latter also describes a computer program product having computer-executable instructions for performing the aforementioned method.

According to a further parallel aspect, the invention also describes a fuel cell system having the features of claim 17. This fuel cell system is characterized in particular by the fact that it comprises a control unit which is configured to carry out the corresponding method steps of the method described above.

Further advantageous embodiments of the invention are described below with reference to the drawing.

### BRIEF DESCRIPTION OF THE DRAWINGS

FIG. 1 shows a general schematic diagram of a known fuel cell operating with hydrogen and oxygen as fuel;

FIG. 2 shows an example of a fuel cell stack having three such stacked cells;

FIG. 3 shows an assembled fuel cell stack having a plurality of such cells;

FIG. 4 shows the method steps of a first embodiment in which no PTC element is provided in a PTC cooling circuit;

FIG. 5 shows the method steps of a second embodiment which as first predetermined condition the temperature of a PTC element in a PTC element cooling circuit is used;

FIG. 6 shows an example of one of temperature, voltage and current profiles as a function of the operating time of the first exemplary embodiment;

FIG. 7 shows an alternative exemplary embodiment of temperature, voltage and current profiles as a function of the operating time.

### DETAILED DESCRIPTION OF THE DRAWINGS

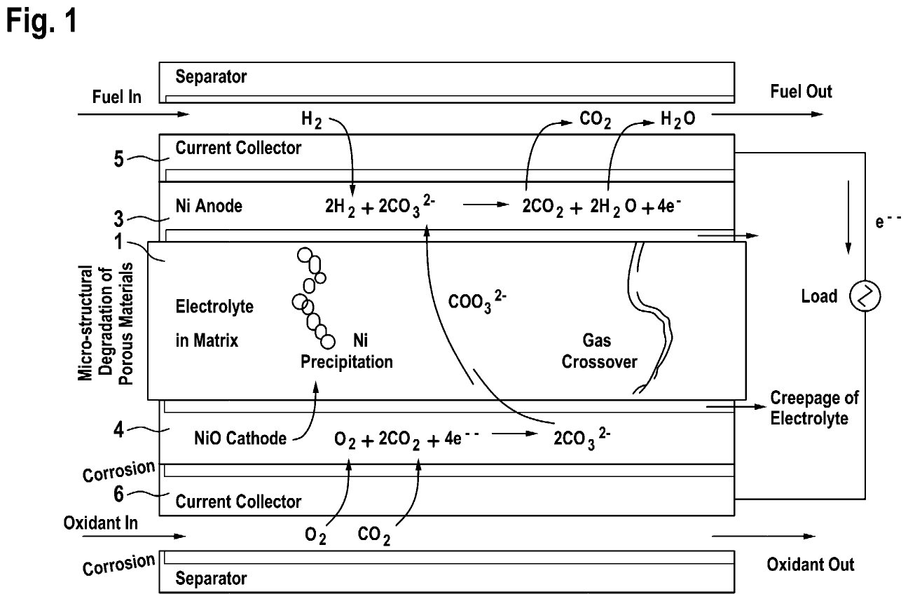

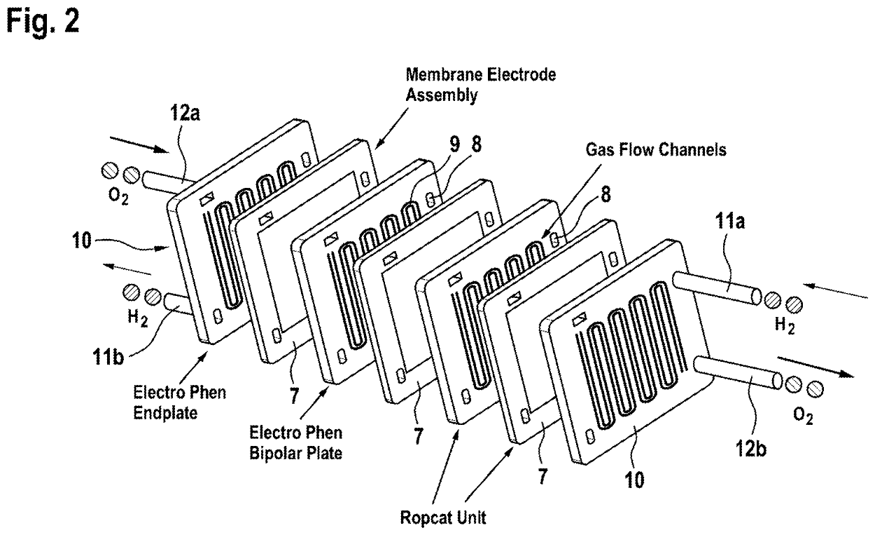

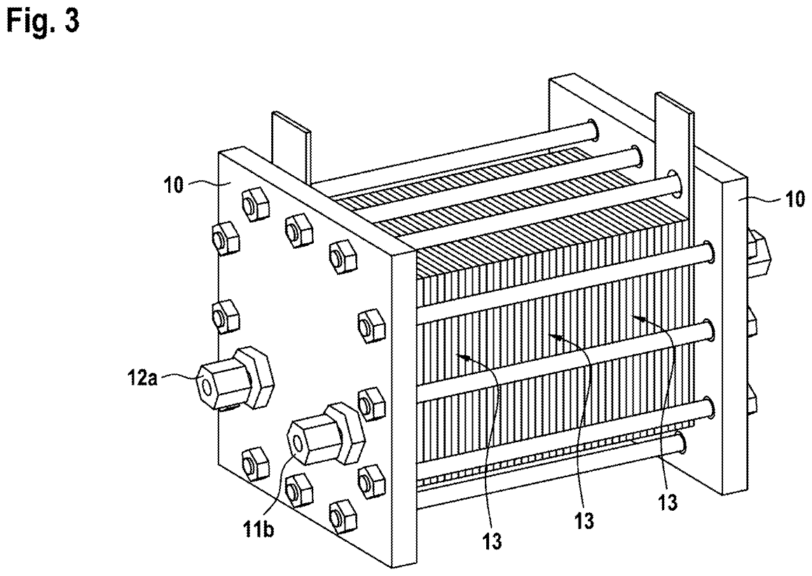

FIG. 1 to 3 have already been described in the introduction to the description with reference to the prior art. In general, the fuel cell stack can be controlled via a control unit and the method according to the invention can be applied during frost start or cold start.

The present example is an example of a PEMFC fuel cell in which hydrogen and air (oxygen) are used as fuel gas and water is obtained as reaction product.

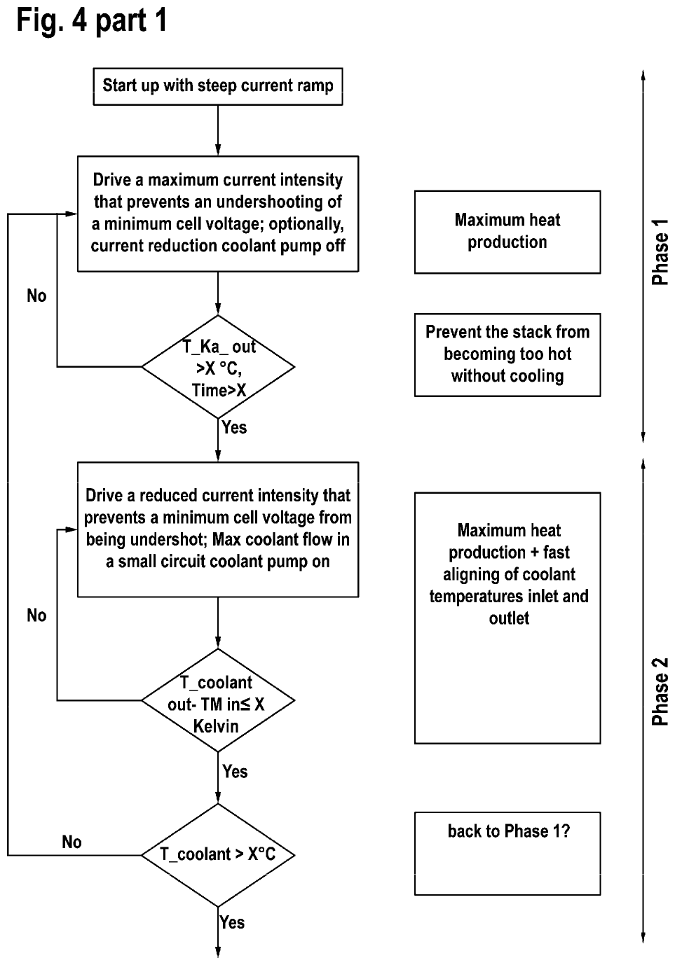

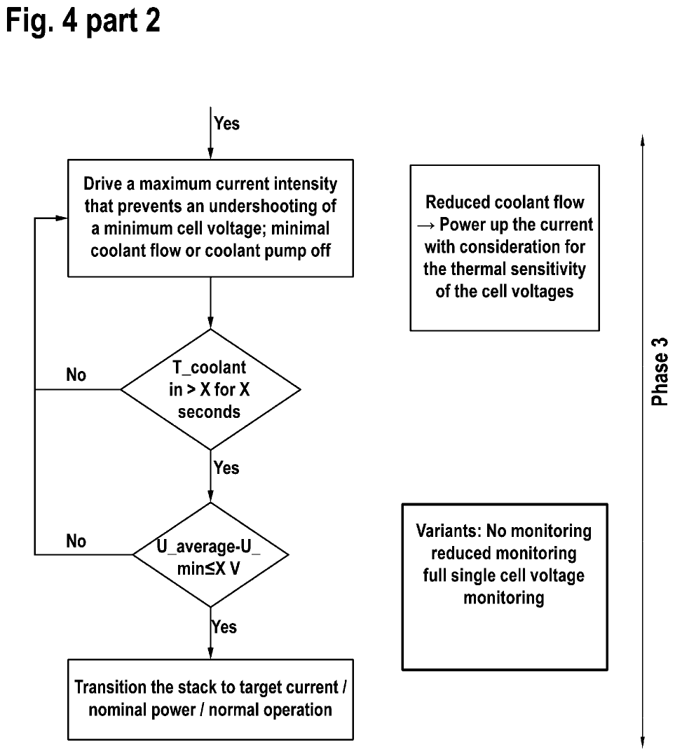

FIG. 4 shows the previously described first to third phase.

In a step denoted by A in the figure, at the beginning of the method as the current increases a maximum current is drawn from the fuel cell stack, while at the same time it is detected whether or not a minimum cell voltage is undershot.

Optionally, should this be the case, the current draw is reduced so that the current flowing out of the cell is reduced, so that the corresponding minimum cell voltage is not undershot.

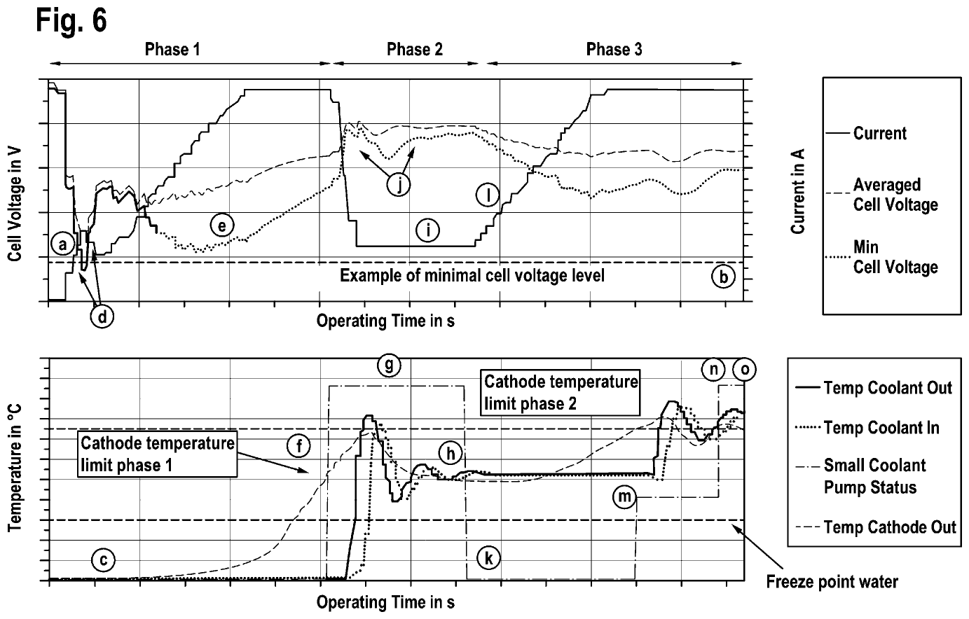

This is shown, for example, in FIG. 6 (graph at the top) on the corresponding lines “Minimum Cell Voltage” (i.e. the minimum voltage prevailing at least an one of the cells of the stack, which can in particular be an edge cell).

At the point denoted by a in FIG. 6, the current (cf. the line denoted by “current” in FIG. 6), which is drawn from the fuel cell stack, increases greatly. Meanwhile, the minimum cell voltage falls below a minimum cell voltage level (cf. dashed line which is denoted by b). This is why the current increase of the drawing is then stopped (cf. region d in FIG. 6) to then increase again slightly (in the region e in FIG. 6).

During the increase of the current up to the region e in FIG. 6 in the first phase, the minimum cell voltage then drops again, but remains above a minimum cell voltage level. The minimum cell voltage is the cell voltage, which is measured, for example, at an edge cell, which can result in stronger heating.

At the end of the first phase, the drawn current remains on a plateau and the corresponding average cell voltage and minimum cell voltage are slowly aligned (cf. FIG. 6: Transition between phase 1 and phase 2 corresponding to the first and second phases). The step a) described at the beginning of the first phase in the claims is performed in the first exemplary embodiment in FIG. 4 until a temperature of the cell or of the fuel cell stack reaches a limit value or until a certain time has elapsed (cf. in FIG. 4 the designation T_Ka_out>X ° C., time>X) after step a) in FIG. 4.

In the present case, the cathode temperature is used as the limit value (cf. FIG. 6 bottom graph). This (cf. “Temp Cathode Out” line) exceeds a predetermined value at point f in FIG. 6. The load is then switched off so that the current decreases again (cf. the beginning of the second phase in FIG. 6 top graph). This corresponds to step c) in the claims. At the same time, the pump is turned on in the cooling circuit (step b) in the claims), so that cooling fluid is pumped through the cell or the cell stack. The temperature at the inlet of the fuel cell stack is described with Temp Coolant In and the temperature at the outlet is described with Temp Coolant Out. These temperatures align during the course of the second phase (cf. corresponding lines in FIG. 6, bottom graph which is described with Temp Coolant In and Temp Coolant Out).

The operation of the pump can be read off on the line “status small coolant pump” in FIG. 6. In the region g in FIG. 6, the pump is operated in the second phase. The Y-axis corresponds to the power of the pump.

As shown in FIG. 4, the second phase is then terminated (ended) when the difference between the temperature at the outlet and the temperature at the inlet (cf. FIG. 4: T_coolant.out-TM.in≤X Kelvin) falls below a certain value (cf. also h in FIG. 6).

Thereafter, as shown in FIG. 4, it is decided whether it is still necessary to transition back into the previously described first phase or whether the transition into the third phase can occur.

If the temperature of the coolant within the cell or the cooling circuit is above a certain temperature (cf. FIG. 4: T_coolant>X ° C.), the transition to the third phase can occur (cf also h in FIG. 6), otherwise the first phase is started again and then the second phase is run through. The corresponding conditions or whether they are met are each queried in a control loop and the corresponding current draw or the corresponding cooling fluid flow is controlled, for example, via a control unit of the system.

In the third phase, as can be seen in FIG. 6, the temperature of the cell is then slowly increased to the operating temperature (cf. top dashed line in FIG. 6 bottom graph). The cathode temperature is measured here.

In this third phase, on the one hand, the drawn current is increased again, as can be seen in point i in FIG. 6, at the same time, in the present exemplary embodiment, the pump is completely discharged in the first part of the third phase, therefore the line is on zero in the region k of FIG. 6. In the second part of the third phase, however, the pump is set at a lower flow rate (reference sign m in FIG. 6). However, in the present exemplary embodiment, the drawn current is then kept on a plateau in this region.

At the end of the third phase, the fuel cell stack then has the operating temperature and it can then be switched from the third phase to a phase of normal operation.

The third phase is also shown in FIG. 4. Here, the step is again shown that the current is increased again and a minimum flow or no flow can flow through the pump. As a condition, when a transition is made to the normal phase, two conditions are mentioned there, namely that the temperature of the coolant flow is above a predetermined value for a certain time (cf. FIG. 4: T_coolant.in >X for X seconds). The difference between the minimum voltage and the average voltage (cf. FIG. 4: U_average−U_min≤X V) is given as a further condition. As soon as this is also above a certain value, a transition is then made to normal operation.

The corresponding lines in FIG. 6 thus correspond to the individual steps of the method shown in FIG. 4.

Nevertheless, the invention is not limited to this specific method, but can take place in its general form as defined in the claims and the general description.

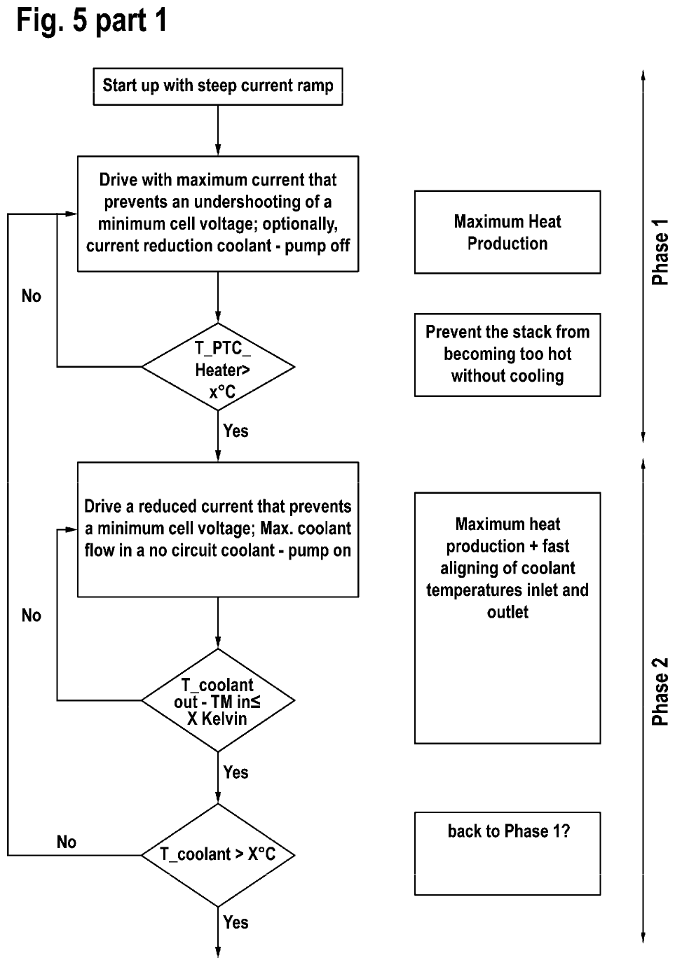

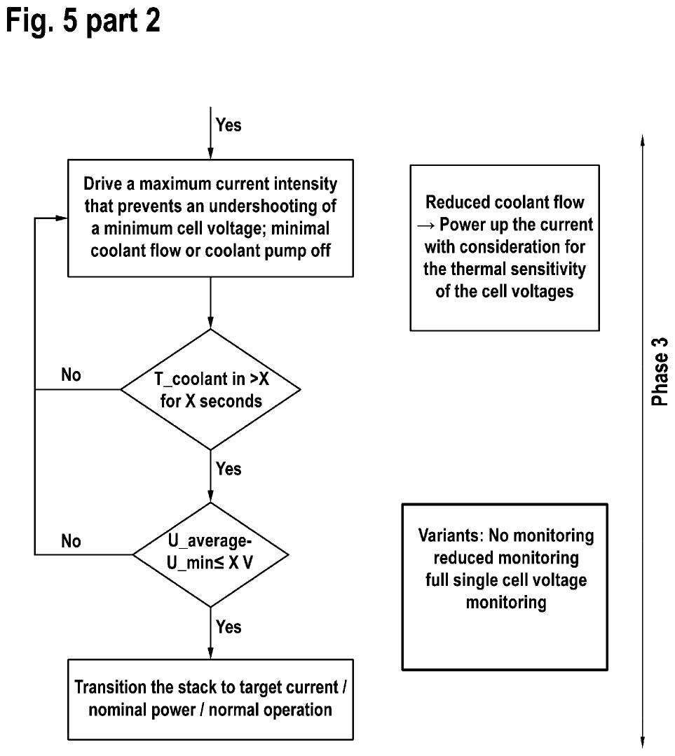

FIG. 5 shows a variant of the first exemplary embodiment in FIG. 4. Here, as the first condition, the corresponding temperature or time is not monitored in the first phase, instead monitoring takes place as to whether a PTC heating element reaches a certain temperature (cf. FIG. 5: T_PTC_Heater>X ° C.). The PTC heater can be switched via the as consumer and thus the current that is drawn from the cells in step a) can be supplied to this PTC element.

The further steps in FIG. 5 are the same as those in FIG. 4.

This variant merely shows the example of the PTC element that consumes the drawn current.

Thus, the cooling circuit can also have a section which is defined as a PTC element cooling circuit. When viewed in relation to the entire cooling circuit, this PTC element cooling circuit can be a smaller cooling circuit which makes up a part of the cooling circuit. The PTC element (positive temperature coefficient), which heats the cooling fluid in the part of the cooling circuit when a voltage is applied to this PTC element, can be contained in this PTC element cooling circuit. The PTC element can be supplied with current to apply the voltage, whereby the cooling fluid is heated up. The heated cooling fluid can also, on the one hand, be conducted through the one or more fuel cells of the fuel cell stack, or, alternatively or additionally, can also supply heat to a heat exchanger upstream of the fuel cell stack.

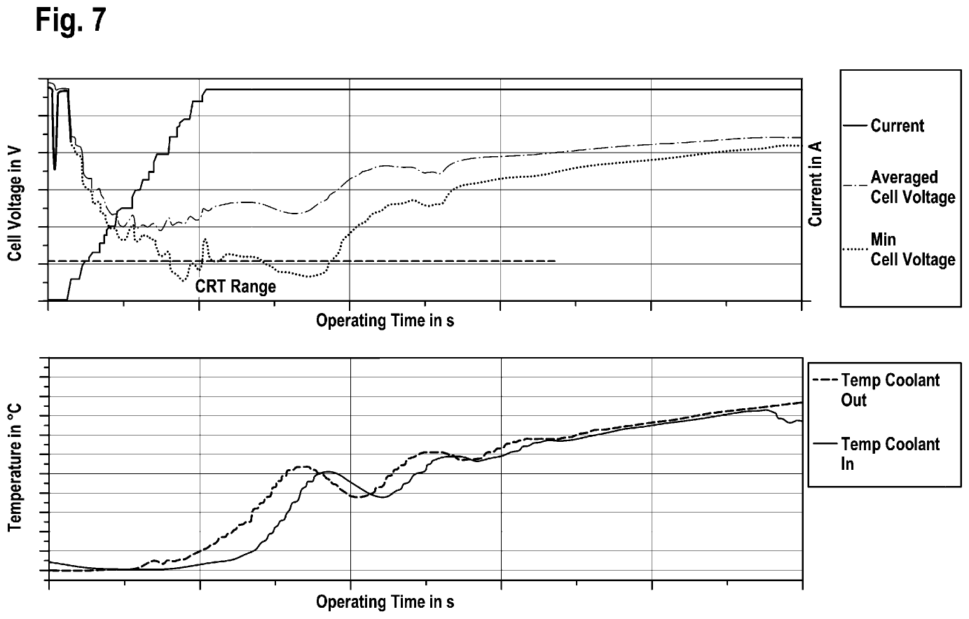

FIG. 7 shows a further variant in which it is not monitored that the minimum cell voltage does not fall below a certain minimum voltage value. This can be performed when the cells have a CRT functionality.

In this case, for example, the anodes are doped with small amounts of iridium or other metals are admixed, which, in the event of an undersupply of the anode due to its own irreversible depletion, for example of iridium, can provide the necessary electrodes in order to keep the electrochemical reaction going and to be able to supply a required system load. Thus, individual or multiple cells or all of the cells in the fuel cell stack can be equipped with a so-called CRT functionality.

In the event of such a CRT functionality, the minimum voltage can indeed fall briefly below a predetermined value or below o, but it then recovers again.

This is shown in FIG. 7 (cf. marking “CRT range).

In this variant, a uniform increase in the current which is drawn from the cells can then be ensured without the current being adjusted in such a way that the minimum voltage is undershot (cf. point d in FIG. 6 where the cells do not have CRT functionality).

In this exemplary embodiment in FIG. 7, for example, only the first step (step a) in the claims) is provided and the current intensity is increased.

At the same time, for example, the ratio of temperature at the cooling fluid inlet and outlet is measured when the corresponding difference falls below a certain value, the fuel cell can be started solely by increased current draw in combination with the CRT function before the transition is then made to normal operation.

### LIST OF REFERENCE SIGNS

1 Solid electrolyte
3 Anode
4 Cathode
5, 6 Current collector plate
7 Membrane electrode assembly
8 Separator
9 Fuel channels
10 End plates
11a, 11b Hydrogen inlet/outlet
12a, 12b Oxygen inlet/outlet
13 Fuel cells
14 Load

1. A method for starting a fuel cell stack at temperatures below the freezing point of a reaction product produced during the reaction between an anode-side fuel and a cathode-side fuel,
wherein the fuel cell stack has a plurality of individual cells having at least one internal cell which is arranged in the stacking direction in the interior of the fuel cell stack and an edge cell which is arranged in the stacking direction at the edge of the fuel cell stack,
and wherein the fuel cell stack is connected to a cooling circuit having cooling fluid for cooling the fuel cell stack, which cooling fluid can be conducted through the fuel cell stack by a pump arranged in the cooling circuit, wherein the method comprises the following step a):
a) applying a load to the fuel cell stack for drawing a first increasing current from the fuel cell stack, thereby decreasing an output voltage of the fuel cell stack, while the pump does not conduct a cooling fluid through the fuel cell stack, until a first predetermined condition is met.

2. The method according to claim 1, wherein the first predetermined condition is a condition as to whether a temperature measured within the fuel cell stack is exceeded and/or a first predetermined time period has elapsed, and/or a PTC element is switched off in a PTC element cooling circuit which makes up a part of the cooling circuit.

3. The method according to claim 1, wherein the during the step a) it is prevented that the cell voltage of at least the edge cell does not fall below a predetermined minimum value.

4. The method according to claim 1, wherein, after step a), the method further includes the following steps b) and c), which are carried out until the one second predetermined condition is met:
b) configuring the pump to conduct the cooling fluid through the fuel cell stack at a first flow rate,
c) reducing the current drawn from the fuel cell stack by adjusting the load.

5. The method according to claim 1, wherein the second predetermined condition is an undershooting of a temperature difference between a coolant temperature at an outlet of the fuel cell stack and a coolant temperature at an inlet of the fuel cell stack.

6. The method according to claim 4, wherein, after steps b) and c), it is checked in a step d) whether a third predetermined condition is met, and if this is not the case, a transition is made back to step a) and steps a) to c) are repeated until the third predetermined condition is met.

7. The method according to claim 6, wherein the third predetermined condition is a condition as to whether a temperature of the coolant is above a predetermined value.

8. The method according to claim 4, wherein, after step d), when the third predetermined condition is met, the steps e) and f) are performed until one or more further predetermined conditions are met, and if this is the case, the fuel cell stack is operated in its normal operation, wherein steps e) and f) are the following:
e) operating the pump such that the cooling fluid is conducted through the fuel cell stack with a second flow rate that is reduced compared to the first flow rate in step b), or that the pump is switched off and no cooling fluid is conducted through the fuel cell stack,
f) applying such a load to draw a second increasing current from the fuel cell stack, thereby decreasing an output voltage of the fuel cell stack.

9. The method according to claim 8, wherein the one or more further predetermined conditions are selected from the group of the following:
that a voltage difference between an average voltage of the fuel cell stack and a minimum voltage of a cell in the fuel cell stack is below a predetermined value,
that the temperature of the coolant is above a predetermined value for a predetermined period of time.

10. The method according to claim 1, wherein the cooling circuit contains a PTC element cooling circuit which makes up a part of the cooling circuit, wherein a PTC element is connected into the PTC element cooling circuit, which PTC element is supplied with current and heats the cooling fluid circulating in the PTC element cooling circuit and supplies it to the fuel cell stack.

11. The method according to claim 10, wherein the current from step a) and/or step e) is supplied to the PTC element.

12. The method according to claim 10, wherein the PTC element cooling circuit supplies heat only to a heat exchanger connected upstream of the fuel cell stack.

13. The method according to claim 1, characterized in that it is not monitored whether a temperature measured within the fuel cell stack is exceeded in step a).

14. The method according to claim 1, wherein, in the method, monitoring is only carried out for the edge cell and/or for one or more cells of the fuel cell stack adjacent thereto and/or for individual blocks of cells in the fuel cell stack as to whether the first and/or second and/or the one or more predetermined conditions are met.

15. The method according to claim 1, wherein the fuel is hydrogen and oxygen, and the fuel cell stack is a PEMFC fuel cell stack and the reaction product is water.

16. The computer program product having computer-executable instructions for carrying out the method according to claim 1.

17. A fuel cell system comprising a fuel cell stack having a plurality of individual cells with at least one inner cell arranged in the stacking direction inside the fuel cell stack and an edge cell arranged in the stacking direction at the edge of the fuel cell stack, and a cooling circuit with cooling fluid for cooling the fuel cell stack, wherein the cooling circuit is connected to the fuel cell stack, wherein the cooling fluid can be conducted through the fuel cell stack by a pump arranged in the cooling circuit, wherein the system comprises a control unit which is configured to apply a load to the fuel cell stack in order to draw a first increasing current from the fuel cell stack, thereby decreasing an output voltage of the fuel cell stack, while the pump does not conduct cooling fluid through the fuel cell stack, until a first predetermined condition is met.
